(19) United States
(12) Patent Application Publication
(10) Pub. No.: US 2011/0097611 A1
(43) Pub. Date: Apr. 28, 2011

(54) BATTERY AND METHOD FOR GENERATING ELECTRICAL POWER USING THE BATTERY

(75) Inventors: Chien-Ho Huang, Taipei City (TW); Yung-Han Huang, Taipei City (TW); Pei-Jung Huang, Taipei City (TW); Tsung-Tien Kuo, Kaohsiung County (TW)

(73) Assignee: TAIWAN HOPAX CHEMICALS MFG. CO., LTD., Kaohsiung County (TW)

(21) Appl. No.: 12/912,455

(22) Filed: Oct. 26, 2010

(30) Foreign Application Priority Data
Oct. 28, 2009 (TW) 098136413

(51) Int. Cl. H01M 10/44; H01M 2/02

(52) U.S. Cl. 429/50; 429/163

(57) ABSTRACT

A battery includes: a container; an electrolyte received in the container; and first and second electrodes disposed in the electrolyte and having different electrical potentials upon exposure to the electrolyte.

### CROSS REFERENCE TO RELATED APPLICATION

This application claims priority of Taiwanese application no. 098136413, filed on Oct. 28, 2009.

### BACKGROUND OP THE INVENTION

1. Field of the Invention

The invention relates to a battery and a method for generating electrical power using the battery, more particularly to a battery including electrodes inert to an electrolyte of the battery.

2. Description of the Related Art

In a conventional battery, one of the electrodes of the battery is consumable or erodible in the process of producing an output voltage. Hence, the life of the battery depends on the thickness of the consumable electrode.

U.S. Pat. No. 3,607,428 discloses a conventional seawater battery that uses a mechanical mechanism to successively raise a water level of seawater in a container for contacting a magnesium electrode. Thus, with each successive cycle, some magnesium of the electrode will be eroded from the bottom. When the magnesium of the electrode is completely consumed, the battery life ends.

The whole disclosure of U.S. Pat. No. 3,607,428 is incorporated herein by reference.

### SUMMARY OF THE INVENTION

The object of the present invention is to provide a battery including electrodes that are not consumable so that the battery life can be permanently extended without replacement of the electrodes.

According to one of the aspect of the present invention, there is provided a battery that comprises: a container; an electrolyte received in the container; and first and second electrodes disposed in the electrolyte and having different electrical potentials upon exposure to the electrolyte. The first and second electrodes are inert to the electrolyte. One of the first and second electrodes is made from a sintered metal powder.

According to another aspect of the present invention, there is provided a battery that comprises: a container; an electrolyte received in the container; and first and second electrodes disposed in the electrolyte and having different electrical potentials upon exposure to the electrolyte. The first and second electrodes are inert to the electrolyte. The electrical potential difference between the first and second electrodes is greater than 450 mV.

According to yet another aspect of the present invention, there is provided a method for generating electrical power. The method comprises: preparing first and second electrodes that are inert to an electrolyte and that have different electrical potentials upon exposure to the electrolyte; placing the first and second electrodes in the electrolyte in a container for producing an output voltage through spontaneous reduction and oxidation of the composition of the electrolyte at the first and second electrodes, respectively, without consuming the first and second electrodes; and supplying a fresh electrolyte into the container and discharging the used electrolyte from the container so as to maintain substantially the composition of the electrolyte in the container for continuing the production of the output voltage.

### BRIEF DESCRIPTION OF THE DRAWINGS

In drawings which illustrate an embodiment of the invention,

FIG. 1 is a schematic view of the preferred embodiment of a battery according to this invention; and

FIG. 2 is a plot of an output current versus an electrical potential difference between two electrodes of the preferred embodiment for Examples 1-6 of this invention.

### DETAILED DESCRIPTION OF THE PREFERRED EMBODIMENT

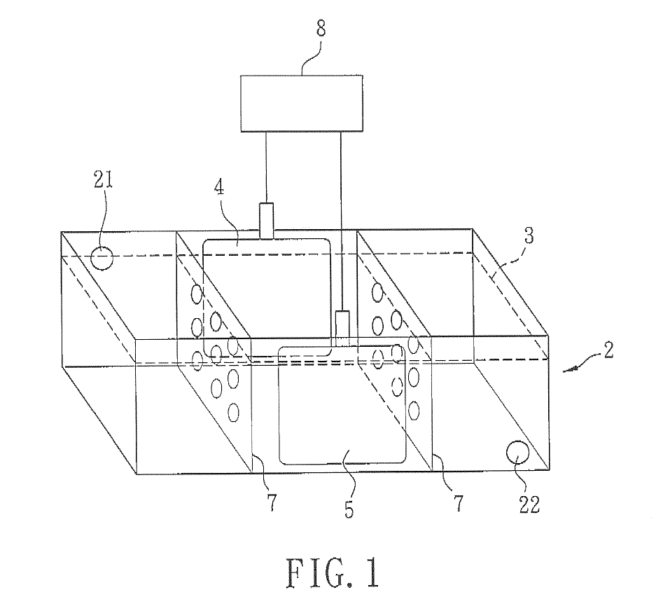

Referring to FIG. 1, the battery of the present invention includes: a container 2; two filter plates 7 disposed in the container 2 to divide the container 2 into three compartments; an electrolyte 3 received in the container 2; and first and second electrodes 4, 5 disposed in the electrolyte 3 and having different electrical potentials upon exposure to the electrolyte 3. The electrical potential of each of the first and second electrodes 4, 5 is measured using a standard calomel electrode as a reference electrode. The first and second electrodes 4, 5 are inert to the electrolyte 3, i.e., they are not consumable in the process of producing an output voltage. The container 2 has an inlet for entrance of a fresh electrolyte 3 into the container 2, and a drainage outlet 22 for discharge of a used electrolyte 3 from the container 2. A coulometer 8 can be connected to the first and second electrodes 4, 5 for measuring the current generated by the battery.

Preferably, the electrical potential difference between the first and second electrodes 4, 5 is greater than 450 mV. More preferably, the first and second electrodes 4, 5 are respectively made from an inert material selected from the group consisting of platinum (Pt), titanium (Ti), and tantalum (Ta).

Preferably, one of the first and second electrodes 4, 5 is made from a sintered metal powder and the other of the first and second electrodes 4, 5 is made from a bimetallic material that has a first metal coated with a second metal different from the first metal.

Preferably, surfaces of the first and second electrodes may be roughened so as to increase the potential difference therebetween.

The metal powder and the first and second metals used for making the first and second electrodes 4, 5 may be obtained from a natural source or a recycled source.

Suitable examples of the first metal can be selected from Ta and Ti, Suitable examples of the second metal can be selected from platinum (Pt), cladding Pt and Pt black.

Preferably, the sintered metal powder is made from a metal selected from tantalum (Ta), niobium (Nb) and titanium (Ti).

Suitable examples of the electrolyte 3 may be seawater and industrial waste waters that have been treated and that have salts dissolved therein in a constant composition. Preferably, the electrolyte 3 is seawater.

The method of generating electrical power using seawater as the electrolyte 3 includes placing the first and second electrodes 4, 5 in the seawater in the container 2 for producing an output voltage through spontaneous reduction and oxidation of the composition of the seawater at the first and second electrodes 4, 5, respectively, without consuming the first and second electrodes 4, 5; and supplying a fresh seawater into the container 2 and discharging the used seawater from the container 2 so as to maintain substantially the composition of the seawater in the container for continuing the production of the output voltage.

The following Examples are provided to illustrate the merits of the preferred embodiment of the invention, and should not be construed as limiting the scope of the invention.

### Example 1

A body of seawater (30° C.) was added into a container to fill the container to a predetermined level. A continuous seawater flow (30° C.) was subsequently provided to flow through the container. Two platinum (Pt) electrode plates (2 cm×2 cm and 5 cm×8 cm) having electrical potentials of 470.1 mV and 479.9 mV (a difference of 9.8 mV), respectively, were immersed in the seawater in the container to form the battery. The battery was then connected in series to a coulometer used for measuring an output current generated by the battery. A steady current of 0.05 μA was measured.

### Example 2

A body of seawater (30° C.) was added into a container to fill the container to a predetermined level. A continuous seawater flow (30° C.) was subsequently provided to flow through the container. A titanium (Ti) electrode plate (5 cm×7.5 cm) and a tantalum (Ta) electrode plate (5 cm×7.5 cm) having electrical potentials of 38 mV and 319.8 mV (a difference of 67 mV) respectively, were immersed in the seawater in the container to form the battery. The battery was then connected in series to a coulometer used for measuring an output current generated by the battery. A steady current of 15 μA was measured.

### Example 3

A body of seawater (30° C.) was added into a container to fill the container to a predetermined level. A continuous seawater flow (30° C.) was subsequently provided to flow through the container. A platinum (Pt) electrode plate (5 cm×8 cm) and a titanium (Ti) electrode plate (3 cm×5 cm) having electrical potentials of 479.9 mV and 386.8 mV (a difference of 93.1 mV), respectively, were immersed in the seawater in the container to form the battery. The battery was then connected to a coulometer used for measuring an output current generated by the battery. A steady current of 50 μA was measured.

### Example 4

A body of seawater (30° C.) was added into a container to fill the container to a predetermined level. A continuous seawater flow (30° C.) was subsequently provided to flow through the container. A platinum (Pt) electrode plate (5 cm×8 cm) and a tantalum (Ta) electrode plate (2.4 cm×5 cm) having electrical potentials of 479.9 mV and 319.8 mV (a difference of 160.1 mV), respectively, were immersed in the seawater in the container to form the battery. The battery was then connected to a coulometer used for measuring an output current generated by the battery. A steady current of 0.12 mA was measured.

### Example 5

A body of seawater (30° C.) was added into a container to fill the container to a predetermined level. A continuous seawater flow (30° C.) was subsequently provided to flow through the container. A platinum-clad titanium electrode plate (5.5 cm×6 cm) and a tantalum (Ta) electrode plate (2.4 cm×5 cm) having electrical potentials of 804.8 mV and 319.8 mV (a difference of 485 mV) respectively, were immersed in the seawater in the container to form the battery. The battery is then connected to a coulometer used for measuring an output current generated by the battery. A steady current of 0.35 mA was measured.

### Example 6

A body of seawater (30° C.) was added into a container to fill the container to a predetermined level. A continuous seawater flow (30° C.) was subsequently provided to flow through the container. A platinum-clad titanium electrode plate (5.5 cm×6 cm) and a porous sintered tantalum (Ta) electrode (containing 3 Ta pellets made from recycled chip tantalum capacitors, the size of each being 3.4 mm×3.4 mm×1.9 mm) having electrical potentials of 804.8 mV and 127.2 mV (a difference of 677.6 mV), respectively, were immersed in the seawater in the container to form the battery. The battery was then connected to a coulometer used for measuring an output current generated by the battery. A steady current of 1.7 mA was measured.

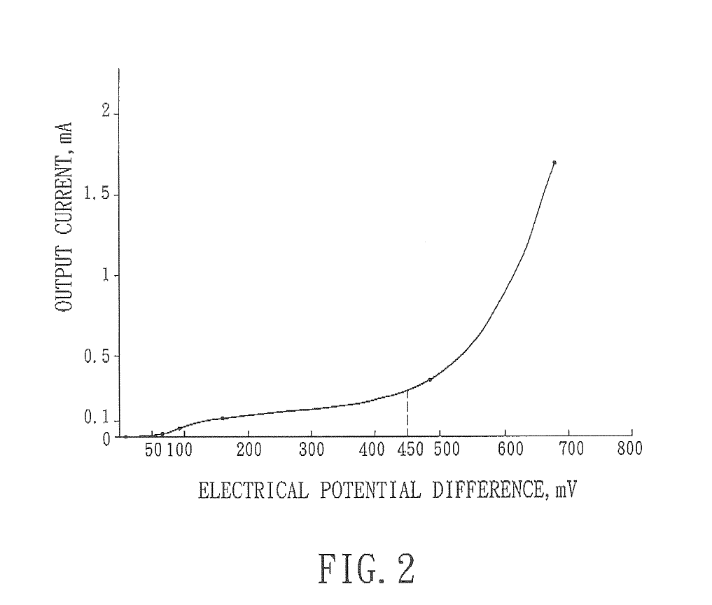

FIG. 2 shows that the preferred embodiment of this invention exhibits a sharp increase in the output current when the electrical potential difference between the first and second electrodes 4, 5 is greater than about 450 mV.

By enlarging the electrical potential difference between the electrolyte-inert first and second electrodes 4, 5 of the battery of this invention, a permanent battery without consuming the electrodes can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass such modifications and equivalent arrangements.

What is claimed is:

1. A battery comprising:
a container;
an electrolyte received in said container; and
first and second electrodes disposed in said electrolyte and having different electrical potentials upon exposure to said electrolyte, said first and second electrodes being inert to said electrolyte;
wherein one of said first and second electrodes is made from a sintered metal powder.

2. The battery of claim 1, wherein the other of said first and second electrodes is made from a bimetallic material that has a first metal coated with a second metal different from the first metal.

3. The battery of claim 2, wherein said second metal is selected from platinum (Pt), cladding Pt, and Pt black.

4. The battery of claim 2, wherein said first metal is selected from tantalum (Ta) and titanium (Ti).

5. The battery of claim 1, wherein said sintered powder is made from a metal selected from Ta, niobium (Nb) and Ti.

6. The battery of claim 1, wherein said electrolyte is seawater.

7. A battery comprising:
a container;
an electrolyte received in said container; and
first and second electrodes disposed in said electrolyte and having different electrical potentials upon exposure to said electrolyte, said first and second electrodes being inert to said electrolyte;
wherein the electrical potential difference between said first and second electrodes is greater than 450 mV.

8. The battery of claim 7, wherein one of said first and second electrodes is made from a sintered metal powder.

9. The battery of claim 8, wherein the other of said first and second electrodes is made from a bimetallic material that has a first metal coated with a second metal different from the first metal.

10. The battery of claim 7, wherein said first and second electrodes are respectively made from an inert material selected from the group consisting of platinum (Pt), titanium (Ti), and tantalum (Ta).

11. The battery of claim 7, wherein said electrolyte is seawater.

12. A method for generating electrical power, comprising:
preparing first and second electrodes that are inert to an electrolyte and that have different electrical potentials upon exposure to the electrolyte;
placing the first and second electrodes in the electrolyte in a container for producing an output voltage through spontaneous reduction and oxidation of the composition of the electrolyte at the first and second electrodes, respectively, without consuming the first and second electrodes; and
supplying a fresh electrolyte into the container and discharging the used electrolyte from the container so as to maintain substantially the composition of the electrolyte in the container for continuing the production of the output voltage.

13. The method of claim 12, wherein the electrical potential difference between the first and second electrodes is greater than 450 mV.

14. The method of claim 12, wherein one of the first and second electrodes is made from a sintered metal powder.

15. The method of claim 14, wherein the other of the first and second electrodes is made from a bimetallic material that has a first metal coated with a second metal different from the first metal.

16. The method of claim 12, wherein the electrolyte is seawater.
